(19) United States
(12) Patent Application Publication
(10) Pub. No.: US 2006/0139793 A1
(43) Pub. Date: Jun. 29, 2006

(54) Method of fabricating a workpiece from a sheet of material

(76) Inventors: Song Cheh Ser, Singapore (SG); Weng How Leong, Singapore (SG)

Correspondence Address: COOPER & DUNHAM, LLP, 1185 AVENUE OF THE AMERICAS, NEW YORK, NY, 10036, US

(21) Appl. No.: 11/292,932

(22) Filed: Dec. 1, 2005

(30) Foreign Application Priority Data
Dec. 1, 2004 (SG) 200407252-6
Mar. 21, 2005 (SG) 200502876-6

(51) Int. Cl. G11B 17/00

(52) U.S. Cl. 360/97.01

(57) ABSTRACT

A method of fabricating a workpiece from a sheet of material is provided. The method begins by defining a bending line on the sheet of material. A slot having an edge positioned at the bending line is then stamped into the sheet of material. The sheet is then bent along the bending line without affecting the edge, which remains flat. The edge forms an exterior right angle on the workpiece.

### TECHNICAL FIELD

The present invention relates to a method of fabricating a workpiece from a sheet of material. In particular, it relates to a method of fabricating the base of hard disk drives from a sheet of metal.

### BACKGROUND

A hard disk drive (HDD) is a mass data storage device commonly used in computers. A hard disk drive is comprised of a number of electronic and mechanical components, including a spindle motor assembly and a printed circuit: board assembly, which are mounted on a housing. A conventional HDD housing includes a base and a top cover within which the electronic and mechanical components are mounted and enclosed. The base typically includes a metal framework having enough strength and rigidity to provide structural and functional support to these electronic and mechanical components.

Presently, the bases of hard disk drives, such as 3.5 inch and 2.5 inch hard disk drives are fabricated in mass production by die-casting. In a die casting process, metal materials such as aluminum alloy are heated to a molten state. The molten material is injected into a die to form a hard disk base with necessary shapes and profiles. The base is then allowed to cool down until it has solidified, and is then removed from the die.

Fabricating hard disk bases by die casting encounters a number of problems. Firstly, since the metal material must be melted, high equipment and process costs are inevitable relative to manufacturing processes carried out at room temperature (cold processing). Secondly, it takes considerable amount of time for the die cast product to cool down from the molten state, for example over 600 degrees Celsius for aluminum alloy. Therefore, the production cycle time is much longer than cold processing. Further, hard disk drive bases made by die-casting require many subsequent treatment processes, such as trimming, deburring, stress relieving and coating. Such factors make a die casting a hard drive base extremely expensive.

It is therefore desirable to provide a low cost and high productive solution for fabricating hard disk drive base so that to overcome the problems faced by die-casting.

### SUMMARY

The present invention provides for a method and apparatus for fabricating a workpiece from a sheet of material. Several inventive embodiments of the present invention are described below.

According to one embodiment of the present invention, a method of fabricating a workpiece from a sheet of material is provided. The method begins by defining a bending line on the sheet of material. A slot having an edge positioned at the bending line is then stamped into the sheet of material. The sheet is then bent along the bending line without affecting the edge, which remains flat. The edge forms an exterior right angle on the workpiece.

In another embodiment of the present invention, a hard disk drive base formed from a sheet of material is provided. The base includes a center segment having a top surface for supporting a spindle motor assembly of a hard disk drive. A first sidewall is attached to the center segment along a first bending line. The first sidewall includes a first slot having an edge positioned at the first bending line. The edge forms an exterior right angle

### BRIEF DESCRIPTION OF THE DRAWINGS

These and other aspects and advantages of the present invention will be described in detail with reference to the accompanying drawings, in which:

FIG. 1 is a perspective view of a sheet metal stock for fabricating a hard disk drive base according to one embodiment of the present invention;

FIGS. 2A to 2G are partial cross sectional views showing a process of fabricating a hard disk drive base using a sheet metal stock of FIG. 1

FIG. 3A is a perspective view showing a sheet metal stock for fabricating a hard disk drive base made after the step shown in FIG. 2B;

FIG. 3B is a cross sectional view showing sheet metal stock for fabricating a hard disk drive base having a second sidewall formed thereon.

FIG. 4A is a perspective view showing a hard disk drive base having two sidewalls formed according to one embodiment of the present invention;

FIG. 4B is a partially enlarged cross sectional view of FIG. 4A along A-A;

FIG. 4C is a perspective view showing a hard disk drive base having three sidewalls formed according to one embodiment of the present invention;

FIG. 5 is a perspective view showing a hard disk drive base formed according to one embodiment of the present invention having flat surface clearances formed for receiving a top cover;

FIGS. 6A to 6E and 6G are partial cross sectional views showing a process of fabricating a hard disk drive base according to another embodiment of the present invention;

FIG. 6F is a partially enlarged view of FIG. 6E;

FIG. 6H is a partially enlarged view of FIG. 6G.

FIG. 7 is a perspective view showing a hard disk drive base formed according to the embodiment shown in FIGS. 6A-6H.

FIG. 8 is perspective view showing a sheet of material for fabricating a workpiece according to a further embodiment of the present invention;

FIG. 9 is a perspective view showing a workpiece fabricated from bending a sheet of material of FIG. 8 having an exterior right angle edge formed thereon;

FIG. 10 is a perspective view showing a sheet of material for fabricating a base plate for a hard disk drive according to a further embodiment of the present invention;

FIG. 11 is a perspective view showing a base plate for a hard disk drive fabricated from bending a sheet of material of FIG. 10.

### DETAILED DESCRIPTION OF THE PREFERRED EMBODIMENTS

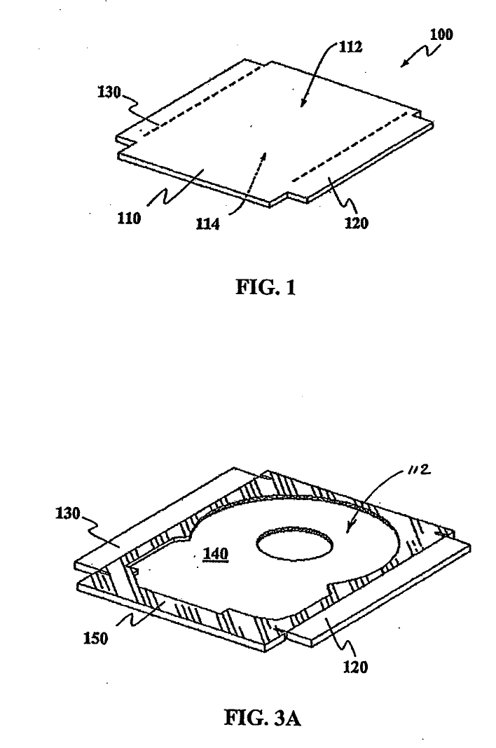

As shown in FIG. 1, a sheet of material 100 is provided for fabricating a hard disk drive base according to the present invention. By way of example, sheet of material 100 may be a sheet metal stock, such as an aluminum alloy sheet having a thickness of about 2 millimeters (mm). Sheet metal stock 100 has a center portion 110, a first border portion 120 adjacent to one side of center portion 110 and a second border portion 130 adjacent to another side of center portion 110. Center portion 110 also has a bottom surface 114 opposite to a top surface 112.

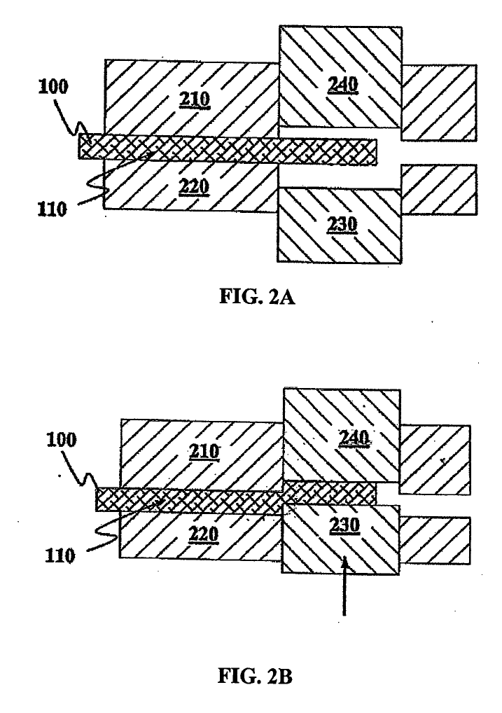

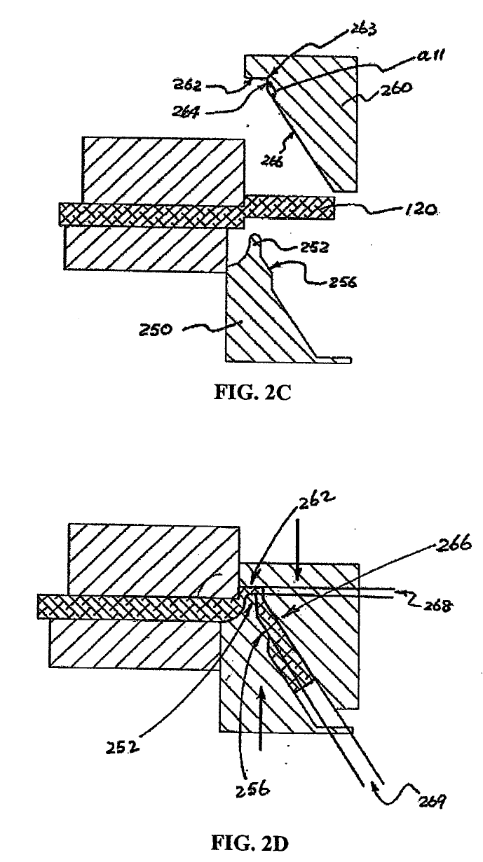

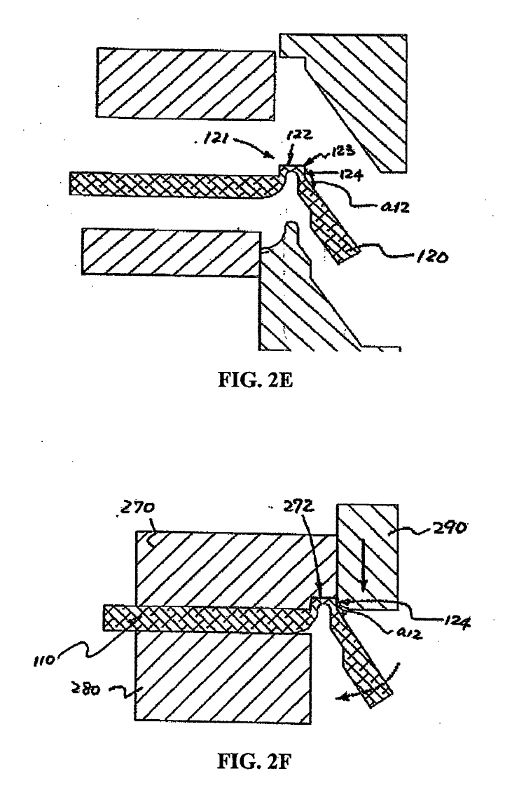

To fabricate the hard disk drive base, sheet metal stock 100 is placed between a first upper die 210 and a first lower die 220, with center portion 110 held between first upper and lower dies 210 and 220, as shown in FIG. 2A. A first punch 230 is moved towards a first pad 240 to press and to deform sheet metal stock 100 to form a depression 140 at top surface 112, as shown in FIG. 2B and FIG. 3A. Depression 140 is to support a spindle motor assembly and an actuator motor assembly (not shown) of a hard disk drive. Between depression 140, first and second border portion 120 and 130 there is a periphery area 150.

FIGS. 2C, 2D, and 2E illustrate a second punch 250 that is moved to press first border portion 120 against a second pad 260. Second pad 260 has a first contact surface 262, a second contact surface 264 and a third contact surface 266. First and second contact surfaces 262 and 264 form an interior right angle edge 263. Third contact surface 266 extends from second contact surface 264 with an included angle a11. In one embodiment of the present invention, the width of first contact surface 262 is about 2 mm, the height of second contact surface 264 is about 1 mm, and included angle a11 is about 150 degrees. Second punch 250 should also have a tip 252 of width less than the width of second contact surface 262 and a slope 256 parallel to third contact surface 266 of second pad 260.

When second punch 250 and second pad 260 are moved towards each other to a closed position, a first gap 268 is formed between tip 252 and first contact surface 262, and a second gap 269 is formed between slope 256 and third contact surface 266, as shown in FIG. 2D. In this embodiment, first gap 268 and second gap 269 are narrower than the thickness of sheet metal stock 100.

When moved to the closed position, the material between second punch 250 and second pad 260 is forced to flow into and fill the cavity defined by first contact surface 262, second contact surface 264 and tip 252. As a result, the material forced into the cavity forms a ridge 121 at one end of first border portion 120. Ridge 121 includes a first end surface 122 and a second end surface 124. First and second end surface 122 and 124 form an exterior right angle edge 123, as shown in FIG. 2E. Pressed between slope 256 and third surface 266, first border portion 120 extends from ridge 121 with an included angle a12 which is the same as included angle a11.

A third upper die 270, third lower die 280 and third punch 290 are then provided as shown in FIG. 2F. Third upper die 270 and third lower die 280 hold center portion 110 so that ridge 121 fills into an indentation corner 272 of third upper die 270. Third punch 290 then slides down to engage second end surface 124 such that movement and/or deformation of ridge 121 are prevented. Third punch 290 slides down to further to force first border portion 120 to rotate towards third lower die 280, increasing angle a12. Third punch 290 moves until the included angle a12 is 180 degrees to form a first sidewall 120′, as shown in FIG. 2G. A similar process can be applied to deform second border portion 130 to form second sidewall 130′, as shown in FIG. 3B.

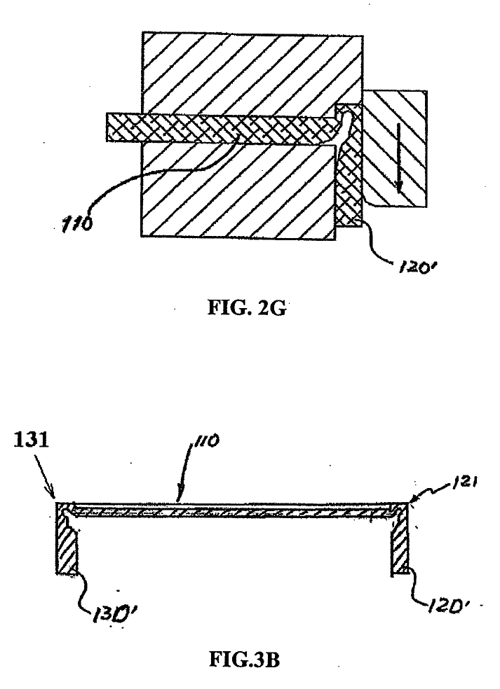

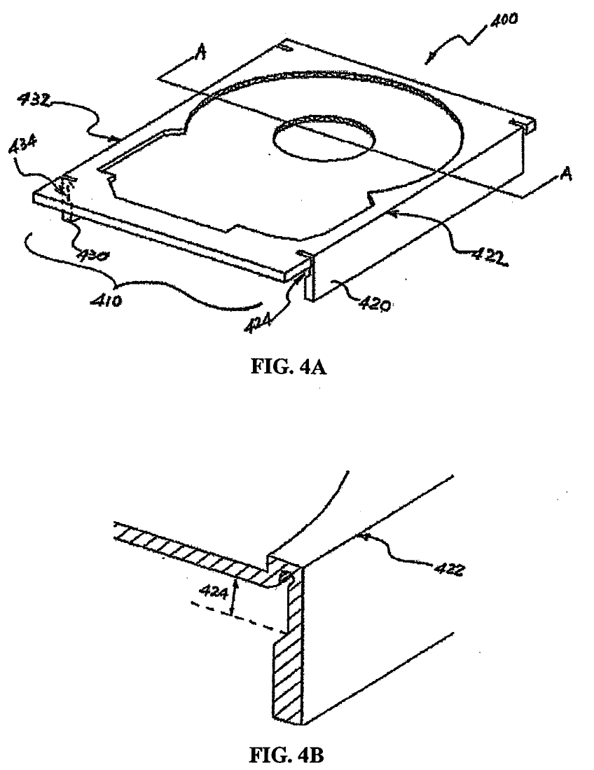

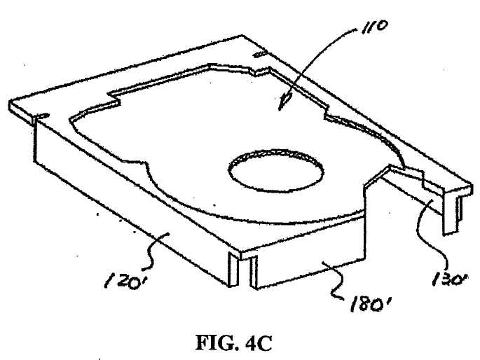

FIG. 4A shows a hard disk drive base 400 fabricated according to one embodiment of the present invention. FIG. 4B is a partially enlarged cross sectional view of FIG. 4A along A-A. The base 400 has a center portion 410, a first sidewall 420 and a second sidewall 430 both extending from center portion 410, with first and second exterior right angle edges 422 and 432 formed between center portion 410 and first sidewall 420 and between center portion 410 and second sidewall 430, respectively. Base 400 is fabricated by deforming a single piece of sheet metal stock according to one embodiment of the present invention. Each sidewall has a material supply segment 424 and 434 adjacent to corresponding exterior right angle edges 422 and 432 (only segment 424 and exterior right angle ridge 422 are shown in FIG. 4B for ease of illustration). Segments 424 and 434 are less thick than the sheet metal stock 100.

According to another embodiment of the present invention, a third sidewall 180′ may also be formed along a third side of center portion 110 and perpendicular to first and second sidewalls 120′ and 130′, as shown in FIG. 4C. Notches 182 and 184 are formed between first sidewall 120′ and third sidewall 180′, and second sidewall 130′ and third sidewall 180′, respectively so that to provide clearances during formation of the first, second and/or third sidewalls. A hard disk drive base having three sidewalls has increased strength and rigidity properties relative to a hard disk drive base having only two sidewalls.

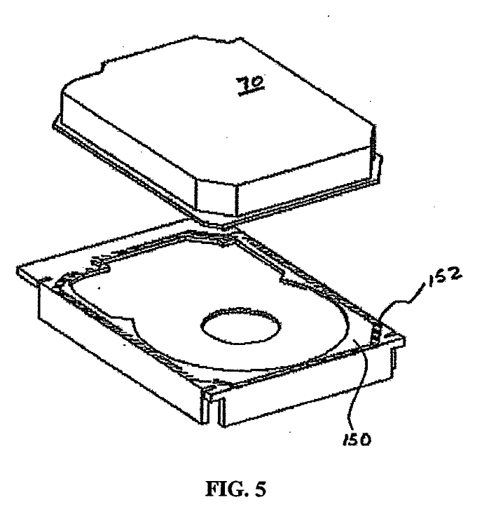

It should be appreciated, with reference to FIG. 5, that since the two or three sidewalls are formed with sharp exterior right angle edges surrounding the center portion, a flat periphery area 150 is obtained having clearances sufficient to fulfill hard disk drive design requirements. A base fabricated according to the above provides an effective flat sealing area 152 at periphery area 150 for receiving a top cover 70.

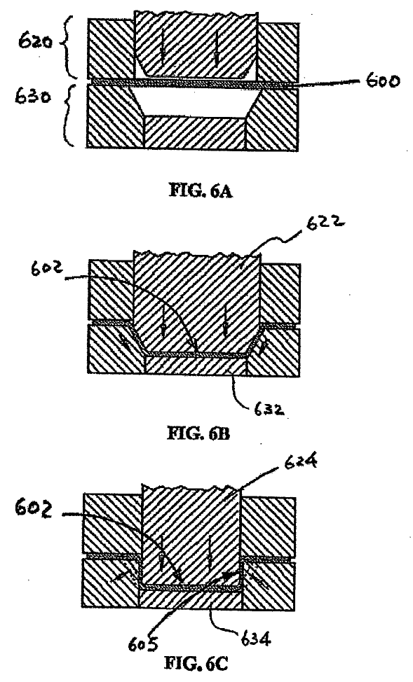

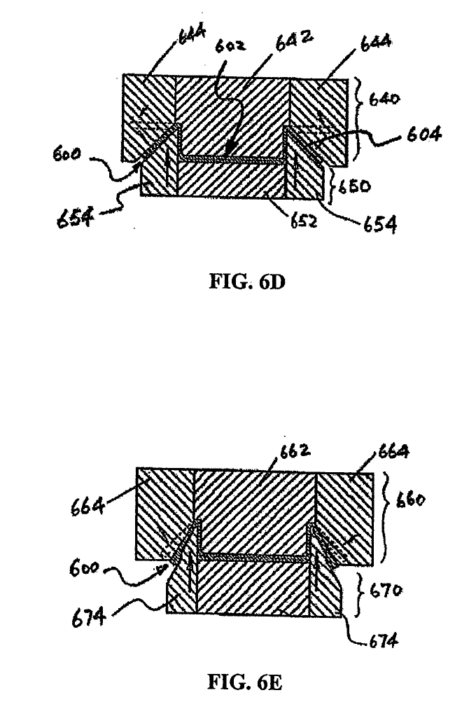

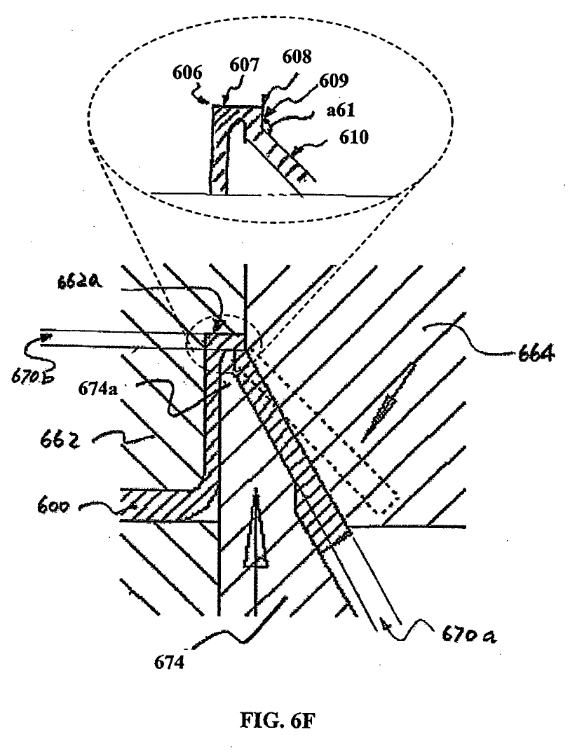

FIGS. 6A to 6H are partial cross sectional views showing a process of fabricating a hard disk drive base according to another embodiment of the present invention. As shown in FIGS. 6A and 6B, a sheet metal stock 600 is placed between upper and lower dies 620 and 630 for processing. Upper die 620 has a first punch 622 which presses sheet metal stock 600 against first pad 632 to form a recess 602, firstly with a sloped recess wall as shown in FIG. 6B. Subsequently, a second punch 624 further presses the sloped recess against a second pad 634 so that to form a straight recess wall 605, as shown in FIG. 6C. During pressing, materials at the sidewall segment are under tension force exerted by second punch 632. As a result, the thickness of the sidewall segment is reduced from the original thickness of sheet metal stock 600. In this embodiment, the thickness of the sidewall segment is reduced to about half of the thickness of sheet metal stock 600.

In a next step as shown in FIG. 6D, the sheet metal stock 600 having a recess 602 formed thereon is placed between upper and lower dies 640 and 650. Upper pad 642 and lower pad 644 hold sheet metal stock 600 in place by pressing recess 602. Lower die 650 has a third punch. 654 which presses sheet metal stock 600 against upper pads 642 and 644 such that periphery portion 604 of sheet metal stock 600 is bent in an angled manner.

In a further step as shown in FIGS. 6E and 6F, a fourth punch 674 presses sheet metal stock 600 with an acute end 674a, against upper pads 662 and 664. When moved towards a closed position, fourth punch 674 and upper pad 664 form a first gap 670a. At the same time, acute end 674a and an end surface 662a form a second gap 670b. Both the first and the second gaps 670a and 670b have a width less than the thickness of sheet metal stock 600. Therefore, fourth punch 674 forces material from sheet metal stock 600 to flow into and fill the cavity defined by first and second gaps 670a and 670b.

As a result, exterior right angle edges 606 and 608, a flat end 607 between exterior right angle edges 606 and 608, a first section 609 and a second section 610 on sheet metal stock 600 are formed. First section 609 is a side surface perpendicular to flat end 607 and intersects flat end 607 at exterior right angle edge 608. Second section 610 extends outwardly from first section 609 and forms an included angle a61.

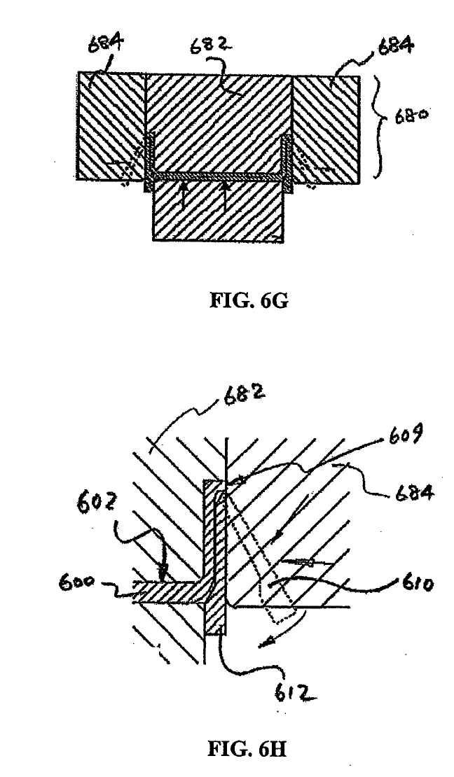

In a next step as shown in FIGS. 6G and 6H, a fifth punch 684 slides down by firstly holding first section 609 within upper pad 682 hence to prevent movement and deformation of first section 609, and further presses against second section 610 to cause second section 610 to rotate with respect to first section 609. Fifth punch 684 eventually straightens second section 610 to form a first sidewall 612 at one side of recess 602. Likewise, a second sidewall 614 is formed at an opposite of recess 602, as shown in FIG. 7.

A hard disk drive base 700 formed according to the embodiment illustrated in conjunction with FIGS. 6A-6H is shown in FIG. 7. Sidewalls 612 and 614 are formed at respective sides of recess 602, and both perpendicular to top surface 702. Recess 602, sidewalls 612 and 614 and top surface 702 form a hard disk base in which, recess 602 has a dimension capable to receive a spindle motor assembly (not shown) having two or more media disks (not shown) mounted thereon. Sidewalls 612 and 614 form an external dimension in compliance with hard disk design standards for fixing the hard disk drive into a chassis of a computer or the like.

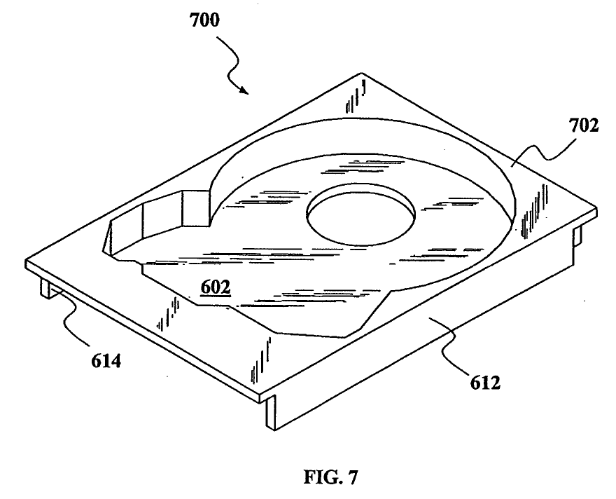

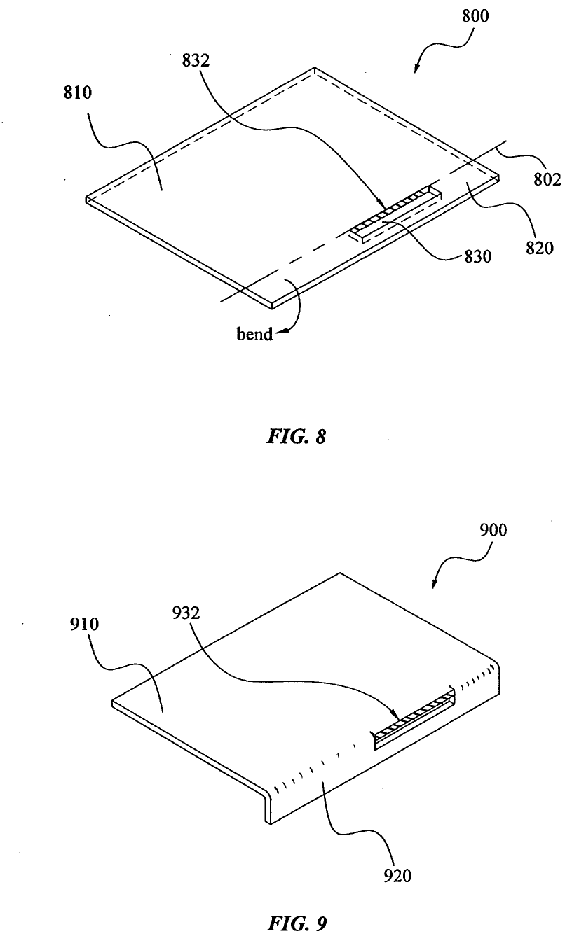

FIG. 8 shows a sheet of material for fabricating a workpiece according to a further embodiment of the present invention. The sheet of material 800 may be a sheet of metal, such as a sheet of aluminum alloy, with a thickness of about 2 mm. A bending line 802 is defined on sheet of material 800, dividing sheet of material 800 into a first segment 810 and a second segment 820. A slot 830 is formed on second segment 820, having an edge 832 positioned at bending line 802. Sheet of material 800 is further processed by bending along bending line 802, as illustrated below in conjunction with FIG. 9.

FIG. 9 shows a workpiece 900 fabricated from bending sheet of material 800 shown in FIG. 8 along bending line 802. Upon bending, first segment 810 of sheet of material 800 forms a center segment 910 of workpiece 900, and second segment 820 forms a sidewall 920 of workpiece 900. Edge 832 is unaffected by the bending and forms an exterior right angle edge 932.

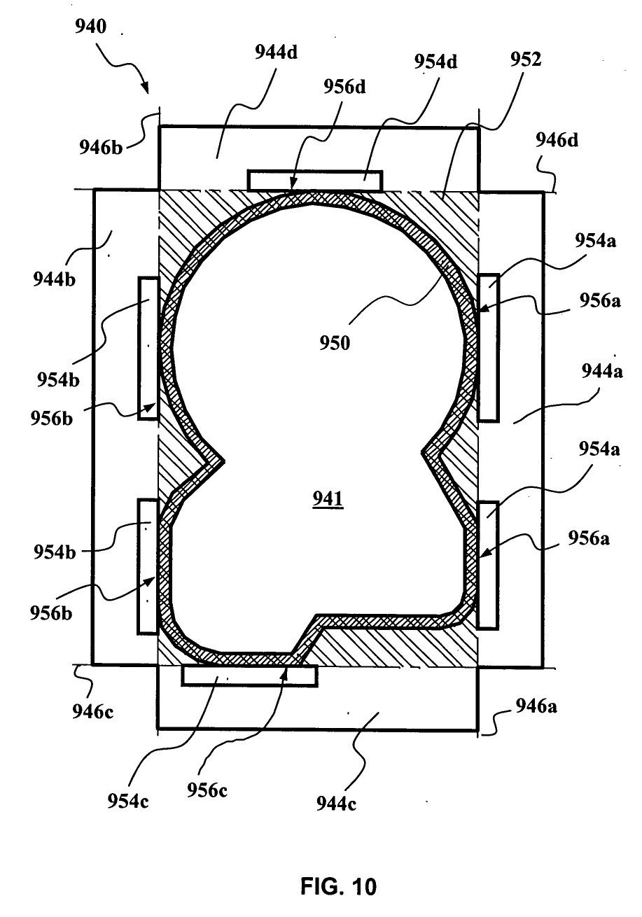

In the example as shown in FIG. 10, a sheet of metal 940 is provided to form a work piece which is a base plate for a disk drive, sheet of metal 940 includes a recess 941. When sheet of metal 940 is processed according to an embodiment of the present invention, recess 941 is formed for receiving a spindle motor assembly, a voice coil motor assembly and a connector of the disk drive. Sheet of metal 940 further includes sidewalls 944a-d, which are to be bent along respective bending lines 946a-d.

Sheet of metal 940 further includes a ridge 952 formed when recess 941 is stamped. Ridge 952 includes a sealing surface area 950, which provides a flat surface to seal base plate 940 to a top cover. Having a flat surface is critical to sealing a disk drive properly. Because the interior of the drive is extremely sensitive and easily damaged by contaminants, the seal between base plate 940 and the top cover must be airtight.

According to this embodiment, slots are stamped in sidewalls 944a, 944b, 944c, and 944d to ensure that sealing surface area 950 is flat. Because portions of sealing surface 950 may be bent when sidewalls 944a-d are formed, slots 954a-d are stamped to prevent contact between edges 956a-d and sidewalls 944a-d. Each slot may be sized to correspond with the proximity of sealing surface 950 to edges 956a-d so that sidewall bending does not effect sealing surface 950. Therefore, because of slots 954a-d, each edge 956a-d remains flat during the bending of sidewalls 944a-d.

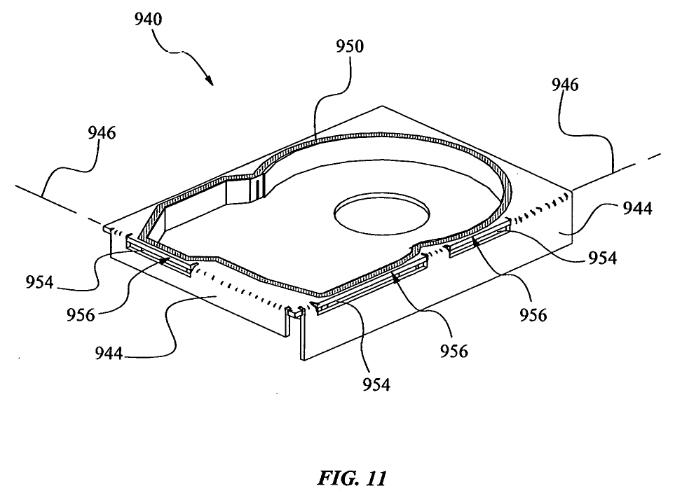

FIG. 11 illustrates base plate 940 after sidewalls 944 have been bent along bending lines 946. Sidewalls 944 include a number of slots 954, which prevented edges 956 from being bent. As a result, edges 956 form an exterior right angle and ensure that sealing surface 950 remain flat to enable airtight sealing with the disk drive top cover.

In view of the foregoing, it should be appreciated that by the successful application of sheet metal stamping technology, new and advantageous methods of fabricating hard disk drive base plate are developed by the present invention through which, many of the problems of fabricating hard disk drive base plate by die casting, e.g. low production output, high equipment and process cost, etc., are successfully overcome.

As the present invention provides new methods of processing sheet metal to form an exterior right angle edge, it should be understood to be applicable to products and applications other than hard disk drives with similar structural and/functional requirements. Although embodiments of the present invention have been illustrated in conjunction with the accompanying drawings and described in the foregoing detailed description, it should be appreciated that the invention is not limited to the embodiments disclosed, and is capable of numerous rearrangements, modifications, alternatives and substitutions without departing from the spirit of the invention as set forth and recited by the following claims.

1. A method of fabricating a workpiece from a sheet of material, comprising:
defining a bending line on the sheet of material;
stamping the sheet of material to form a slot, wherein the slot includes an edge positioned at the bending line; and
bending the sheet of material along the bending line, wherein the edge is to form an exterior right angle.

2. The method as recited in claim 1, wherein the sheet of material is bent into a center segment and a sidewall having the slot.

3. The method as recited in claim 2, further comprising stamping a recess on the center segment, wherein the recess and the edge are to define a ridge.

4. The method as recited in claim 3, wherein the workpiece is a disk drive base and wherein the recess is to support a spindle motor.

5. The method as recited in claim 3, wherein the ridge is to provide a sealing surface to couple to a top cover of the hard disk drive.

6. The method as recited in claim 5, wherein the sealing surface is a flat surface having a width of about 2 mm.

7. A hard disk drive base formed from a sheet of material, comprising:
a center segment having a top surface for supporting a spindle motor assembly of a hard disk drive; and
a first sidewall attached to the center segment along a first bending line,
wherein the first sidewall includes a first slot having an edge forming an exterior right angle positioned at the first bending line.

8. The hard disk drive base plate as recited in claim 9, further comprising a recess stamped into the top surface to define a ridge, wherein the ridge is to provide a sealing surface for coupling to a hard disk drive top cover.

9. The hard disk drive base plate as recited in claim 8, further comprising a second sidewall attached to the center portion along a second bending line, wherein the second sidewall includes a second slot having an edge forming an exterior right angle positioned at the second bending line.

10. The-hard disk drive base plate as recited in claim 9, wherein the ridge includes a first ridge positioned between the center segment and the first sidewall and a second ridge positioned between the center segment and the second sidewall, wherein the first ridge and the second ridge are to provide a sealing surface for coupling to a hard disk drive cover.

11. The hard disk drive base plate as recited in claim 7, wherein the sheet of material is formed from a group consisting of steel, aluminum and alloys thereof.

12. The hard disk drive base plate as recited in claim 11, wherein the thickness of the first ridge and the thickness of the second ridge range from about 1 mm to about 3 mm.

13. The hard disk drive base plate as recited in claim 8, wherein the hard disk drive base is formed by metal stamping.

14. The hard disk drive base plate as recited in claim 13, wherein the recess is to support a hard disk drive spindle motor.

15. A method of fabricating a workpiece from a sheet of material, comprising:
defining a bending line on the sheet of material between a center segment and a sidewall segment;
stamping the sidewall segment to form a slot, wherein the slot includes an edge positioned at the bending line; and
bending the sheet of material along the bending line to form a sidewall from the sidewall segment, wherein the edge of the slot remains flat

16. The method as recited in claim 15, wherein the edge is to form an exterior right angle.

17. The method as recited in claim 16, further comprising stamping a recess on the center segment, wherein the recess and the edge are to define a ridge.

18. The method as recited in claim 17, wherein the workpiece is a disk drive base and wherein the recess is to support a spindle motor.

19. The method as recited in claim 17, wherein the ridge is to provide a sealing surface to couple to a top cover of the hard disk drive.

20. The method as recited in claim 19, wherein the sealing surface is a flat surface having a width of about 2 mm.
